(19) United States
(12) Patent Application Publication
(10) Pub. No.: US 2003/0006247 A1
(43) Pub. Date: Jan. 9, 2003

(54) Ingredient delivery system

(76) Inventors: Jason Olivier, Laguna Beach, CA (US); Jeff Harlan, Corona, CA (US)

Correspondence Address: LEVIN & HAWES, P.O. BOX 4140, LAGUNA BEACH, CA, 92652, US

(21) Appl. No.: 09/930,876

(22) Filed: Aug. 14, 2001

Related U.S. Application Data
(60) Provisional application No. 60/304,611, filed on Jul. 9, 2001.

(51) Int. Cl. B67D 5/00

(52) U.S. Cl. 222/83; 222/144.5

(57) ABSTRACT

An ingredient delivery system is disclosed that provides a system for dispensing of one or two ingredients in a controlled fashion from a container. In one version the system provides a two-ingredient delivery system with a two-chamber container and a piercing sealing cap that allows ingredients sealed in the chambers of the containers to be stored and transported in a safe and uncontaminated fashion. When ready for use the seal can be broken with the piercing cap and the cap opened to dispense the ingredients in a controlled fashion from each chamber individually or from both at once without cross contamination. The system also provides mirror image bottles that have a unique connecting and interlocking feature and a method for fabricating the same.

### RELATED APPLICATIONS

The present application claims priority under 35 USC §119 (e) form U.S. provisional application serial No. 60/304,611 filed Jul. 9, 2001 and entitled An Ingredient Delivery System.

### FIELD OF THE INVENTION

The present invention relates to systems for delivering flowable ingredients and more particularly to an efficient and cost effective delivering system that allows for ease of storage, transportation and dispensing of consumable ingredients.

### BACKGROUND OF THE INVENTION

Systems for storing and delivering flowable products in small units for use by consumers have been around since ancient times. Ceramic and glass jars in use in ancient times are still in use today to deliver innumerable flowable ingredients used by consumers from dry flowable products like salt and sugar to liquid products such as mustard, ketchup, vinegar etc. The important features of all of these systems are being able to maintain freshness of the ingredient before and after first use. Corks secured by a wax seal were among the first attempts to provide a means for sealing the container to preserve freshness and the integrity of the contents of the container. The containers were also used to store the ingredients between use to protect and maintain freshness.

In more recent times various plastic and paper container have come into use for the delivery of flowable consumer products. Simple cork tops have given way to more efficient and durable tops such as screw on plastic or metal tops. In turn may containers used to package flowable consumer products have pouring mechanisms to aid in the dispensing in a uniform and efficient manner the ingredients contained in the bottle or container. Quite often these containers have more than one compartment to hold two or more different ingredients that tend to be used together. One example are various dual containers used to sell and dispense ingredients often used with one another such as catsup and mustard for hamburgers and hot dogs or vinegar and oil for a salad dressing. Although the concept of a dual ingredient container is simple, actual design and manufacture of an inexpensive yet efficient and cost effectively fabricated dual ingredient container-dispenser-secure-shipping and storage container is challenging. In designing and manufacturing a consumer ingredient container a number of criteria must be met. First the container must be light weight yet durable, safely transport the ingredients to the point of sale without breaching the integrity of the container to protect freshness, be capable of being easily opened when the time comes to use the ingredients and be capable of repeated sealing and opening of the container to dispense the ingredients and provide for ease in dispensing in measured quantities.

The last requirement that the container be easy and inexpensive to manufacture in view of the other requirements can be the most difficult to achieve. Often trade offs between ease of use and ease of manufacture have to be made to achieve these requirements in an acceptable manner. The technology of flowable ingredient containers is extensive. There are a number of different patents on various containers including single chamber containers and containers with two or more chambers for storing and dispensing two or more different ingredients. Some of them have pour spouts that allow the user to only dispense one ingredient at a time others have dispenses that allow for the dispensing of the contents of each chamber individually or at the same time from both chambers. However, all of the disclosed systems have various deficiencies that make them inefficient and/or are commercially unacceptable. U.S. Pat. No. 5,588,440 discloses a two-compartment container made from two compartments joined together. It also includes a dispensing device that purportedly allows the dispensing of ingredients from either of the compartments individually or from both at the same time. However, the dispensing system relies on a complicated rotating disk mechanism that requires the precise alignment of two abutting disks in order to position openings in each of the disks to selectively dispense an ingredient in one or both chambers. The system is so complicated that it is subject to malfunctioning and allows for the contamination of the ingredients from one compartment with that in the other once used. The system also lacks an efficient and effective means for joining the compartments for use. U.S. Pat. No. 5,794,819 on the other hand discloses a dual chamber bottle for dispensing two different ingredients. However, this invention, given the design of the dispenser only allows for the dispensing of one ingredient at a time.

An extensive number of other ingredient containers with dispensing devices also exist which have the capability of storing ingredients in a sealed state for storage and transportation. The dispensers on these containers sometimes use a seal over the mouth of the container that separates the dispensing device from the ingredients in the container and a piercing mechanism within the dispensing device to pierce the seal to initiate use. However, although all of the above mentioned concepts have been in use in one form or another throughout the later half of the twentieth century if not before then, to the present no one has successfully designed a container for flowable ingredients that can provide for secure shipment of the container and ingredients without loss of the integrity of the ingredients in the container. A system that will allow for ease of opening and breaking of the seal, repeated dispensing of measured portions of the ingredients in the container, without contamination while maintaining freshness and the integrity of the ingredients. A system that is also easy and economical to manufacture and use without being subject to malfunctioning and that is thus durable, applicable to a broad range of uses and at the same time aesthetically pleasing.

### SUMMARY

Thus, it is an objective of the present invention to provide an ingredient container delivery system that is both functional and aesthetically pleasing. A system that will allow for the secure shipment of the container with ingredient or ingredients in a sealed fashion that maintains the integrity of the ingredients and that allows for the container to be unsealed and repeatedly used to dispense the ingredients in a measured fashion. A system that protects the ingredients from contamination during storage when not in use. A system that is also capable of allowing for the storage and dispensing of two different ingredients separately or together without cross contamination. The system also has the objective of providing an efficient and economical system and method of manufacturing an ingredient delivery system and one that is immune to malfunctioning.

The invention provides these and other features by providing an ingredient delivery system consisting of two symmetrical mirror image interlocking bottles. Each of the bottles has facing joinable surfaces with complementary raised and depressed areas on the joinable surface for positioning and joining the bottles together to form a single two-compartment container. Each of the mirror image bottles can be formed from the same mould. When joined together the open ends of the two mirror image bottles are adjacent to each other and are seal able with a piercable membrane.

In and additional aspect of this invention it provides a five piece-piercing cap attaches to a receiving thread, which is formed adjacent to the outside of the adjacent open ends of the joined mirror image bottles. The five part-piercing cap consists of 1) threaded cap portion, 2) puncture cap portion, 3) a removable retaining ring and 4) two slidable closure caps.

In an additional aspect of the invention the threaded cap portion attaches to the treads adjacent to the open ends of the mirror image bottles when they are joined to form the container. The piercing cap portion with two parallel conduits snaps onto the threaded cap portion and when attached to the threaded cap portion, each of the parallel conduits have a first end which projects down towards an open end of one of the bottles through openings in the threaded cap portion. The piercing cap also has one or more receptacles for receiving a retaining ring to hold the piercing cap in a position where first end of each of the parallel conduits are positioned just above the piercable membrane covering the open ends of the joined mirror image bottles. Upon removal of the retaining ring the piercing cap can be forced down to allow the piercing ends of each of the parallel conduits to cut through the membrane on the open ends of the bottles. Each of the parallel conduits has a second end with separate slidable closure cap portions that when positioned in a closed position, seal the top end of the respective second end of the parallel conduit to which it is attached. The slidable caps, when in the open position, with the retaining ring removed and the membrane cut allow an ingredient in the bottle over which the respective conduit is located to flow out through that conduit.

### BRIEF DESCRIPTION OF THE DRAWINGS

The invention will be better understood by an examination of the following description, together with the accompanying drawings, in which:

FIG. 1 is a perspective view of the complete system of the present invention;

FIG. 2 provides a view of the two chambers that make up the container portion of the present invention;

FIG. 3 is an exploded view of dual nozzle of the present invention;

FIG. 4 is a cross sectional view of the dual nozzle along line I-I of FIG. 1;

FIG. 5 is another cross sectional view of the dual nozzle with one of the sliding caps in the open position;

FIG. 6 is another exploded view of the bottle of the present invention; and

FIG. 7 is an exploded view of nozzle version of the present invention.

### DETAILED DESCRIPTION OF THE PREFERRED EMBODIMENT

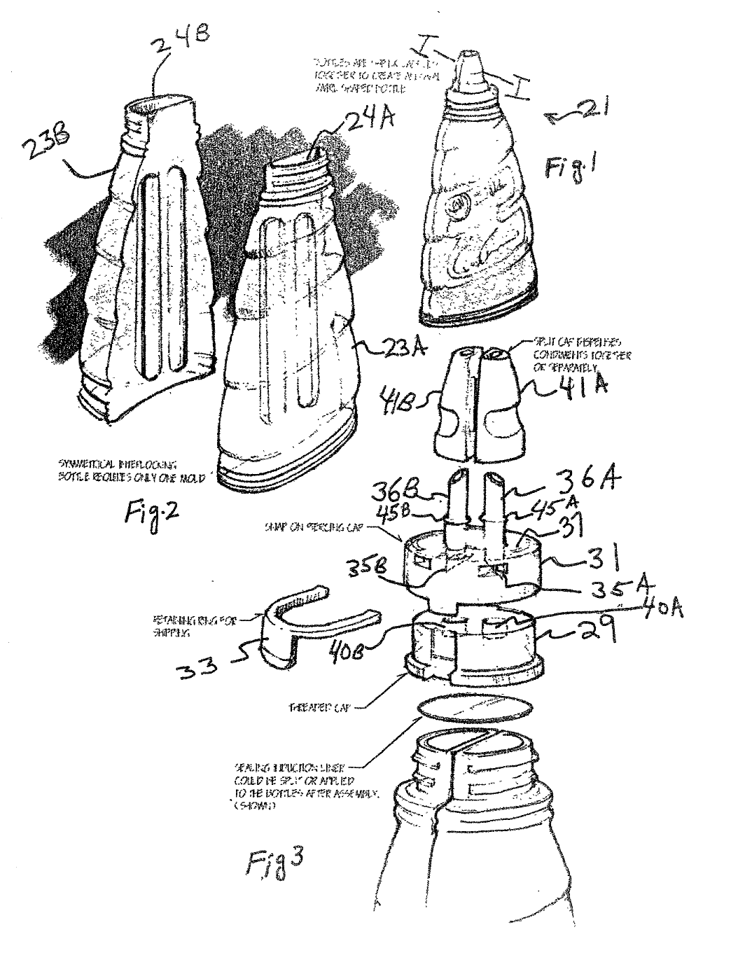

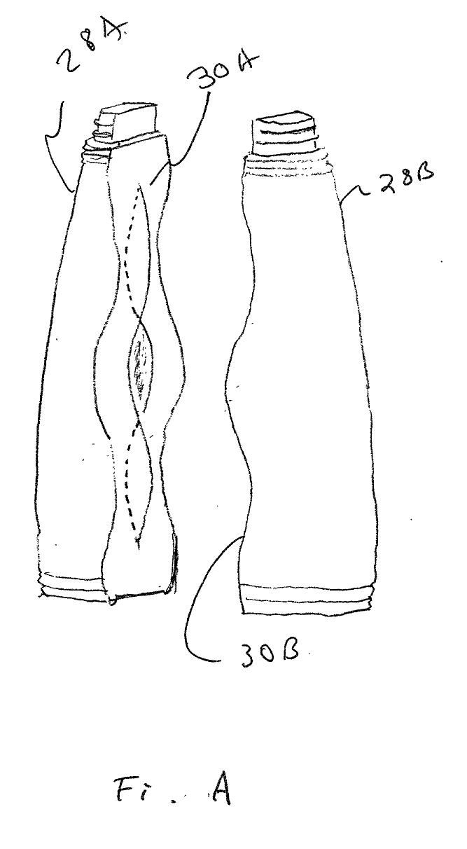

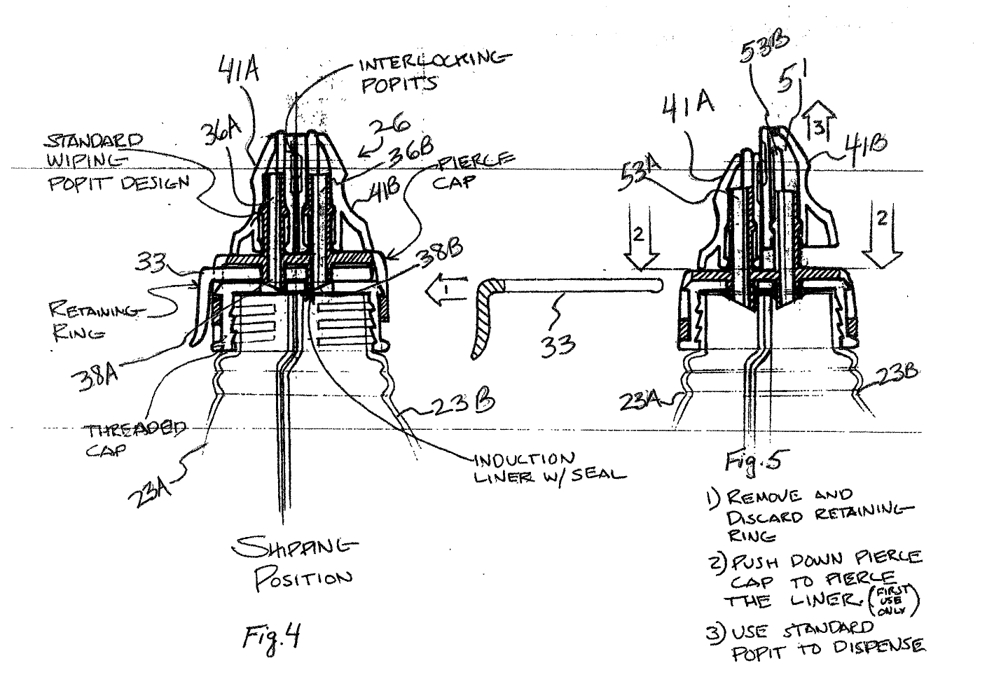

FIG. 1 depicts symmetrical interlocking bottle 21 of the present invention. FIG. 2 depicts the two compartments 23A and 23B that make up bottle 21 of the invention. Sections 23A and 23B are mirror images of one another to create a complete two-compartment bottle system. Both sections 23A and 23B of bottle 21 are totally sealed containers except for top opening 24A and 24B in each. Both bottle 21 sections 23A and 23B have a rib like formation 25A and 25B. Rib like section 25A is depressed and rib like section 25B is raised. Since each bottle 21 section 23A and 23B are mirror images of each other rib 25B of one section fits into rib 25A of the other section which thereby allows the sections 23A and 23B to form an interlocking unit that makes up bottle 21.

FIG. 2A depicts another version of the two bottles that form the dual compartment container when joined. In bottle 28 A and 28B have mutual shaped joinable surfaces 30 A and 30B. In FIG. 2A the joinable surface 30B can only be seen in outline because of the view of bottle 28B however it is complementary to the surface 30A such that they form a tight and snug connection when joined. The bottles shown in FIGS. 2 and 2A can be connected by an adhesive on their joinable surfaces; however, in the preferred embodiment the bottles will be held together by a shrink-wrap covering of a plastic type of material that can also act as the label of the container formed by the joined bottles.

In the preferred embodiment the bottle is constructed of polyprophelene (High Density Plastic) or similar material. Also, in the preferred embodiment the bottle is constructed using a combination blow molding injection method of construction. However, different materials and methods can be used to achieve the same results.

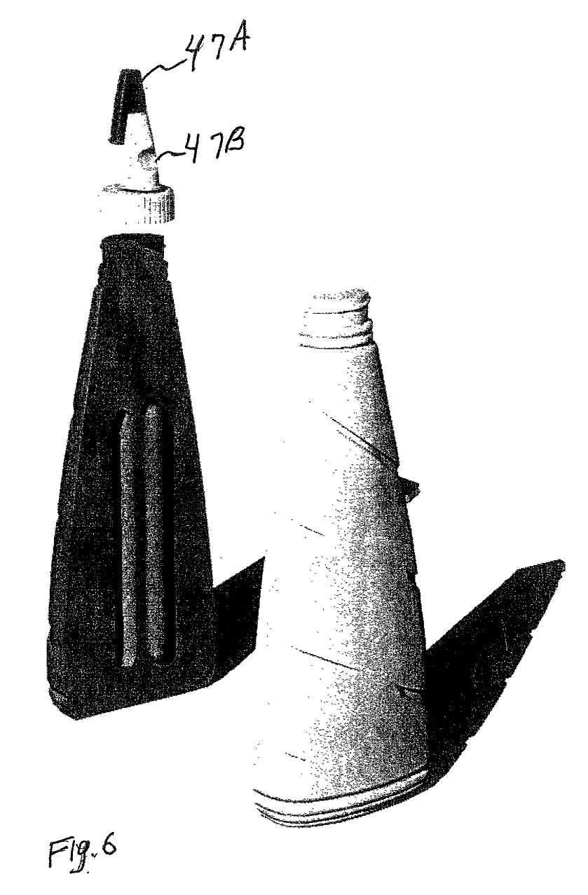

Nozzle 26 (FIG. 3) is composed of a 5-piece piercing cap injection system. From the bottom of the illustration induction-lining 27 is halved in order to seal both compartments 23A and 23B at their openings 24A and 24B respectively. Threaded cap 29 is fastened to bottle 21. Snap on piercing cap 31 sits inside the threaded cap 29 with retaining ring 33 separating the two. Retaining ring 33 fits into the two holes 35A and 35B on the piercing cap 31. Piercing cap 31 has cylindrical conduits 36A and 36B that pass through the top planer structure 36 of cap 31. Conduits 36A and 36B have lower sections 38A and 38B respectively, that are formed into round hollow piercing points. Sliding split caps 41A and 41B attach to the top portions of conduits 36A and 36B that project up out of piercing cap 31.

To use the container 21 when filled with a flow able substance, the consumer removes retaining ring 33 in order to snap the piercing cap 31 onto the threaded cap 29. The consumer does so by pushing down piercing cap 31 which in turn causes the two needle type pieces 38A and 38B on the lower side of the piercing cap 31 to move through openings 39A and 39B of the threaded cap 29 and thereby penetrate the induction liner 27 attached to the bottle 21.

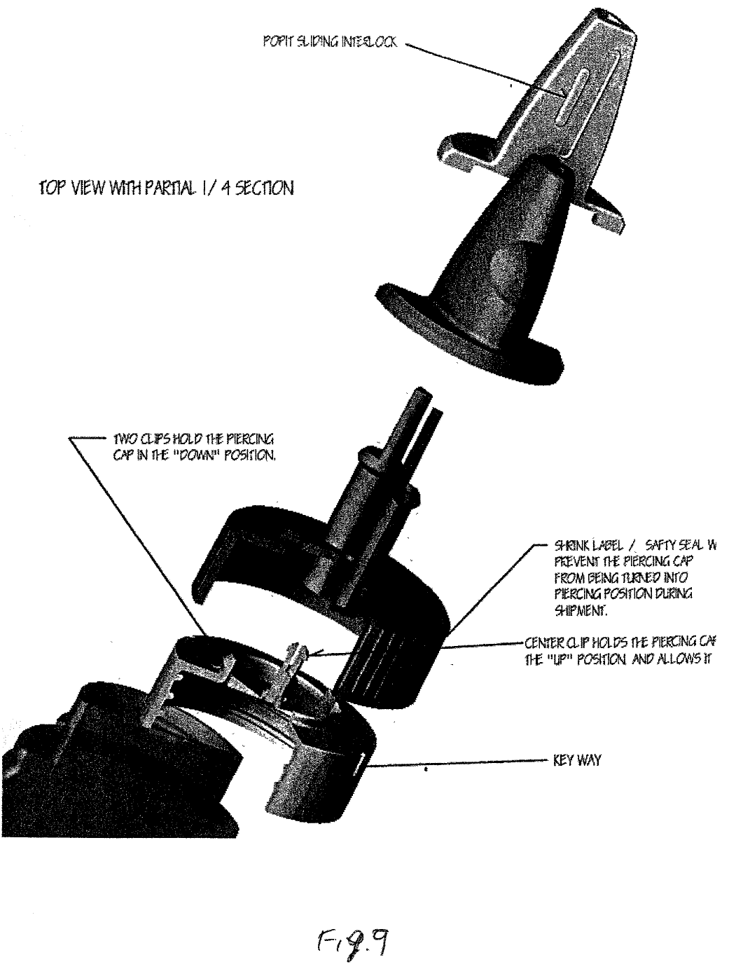

Each sliding cap 41A and 41B moves up and down independently or both together for actuating their use together or independently. Moving nozzle 41A or 41B up opens up the respective conduit 36A or 36B on which that nozzle sits to thereby allow ingredients contained in one of the compartments 23A or 23B of the bottle 21 to flow out. Likewise moving either sliding cap 41A or 41B down closes the conduit over which they are positioned to seal closed the chamber below. Flanges 45A and 45B that surround conduits 36A and 36B are provide a snap point for movement of nozzles 41A and 41B the closed position 47A (FIG. 6) and open position 47B.

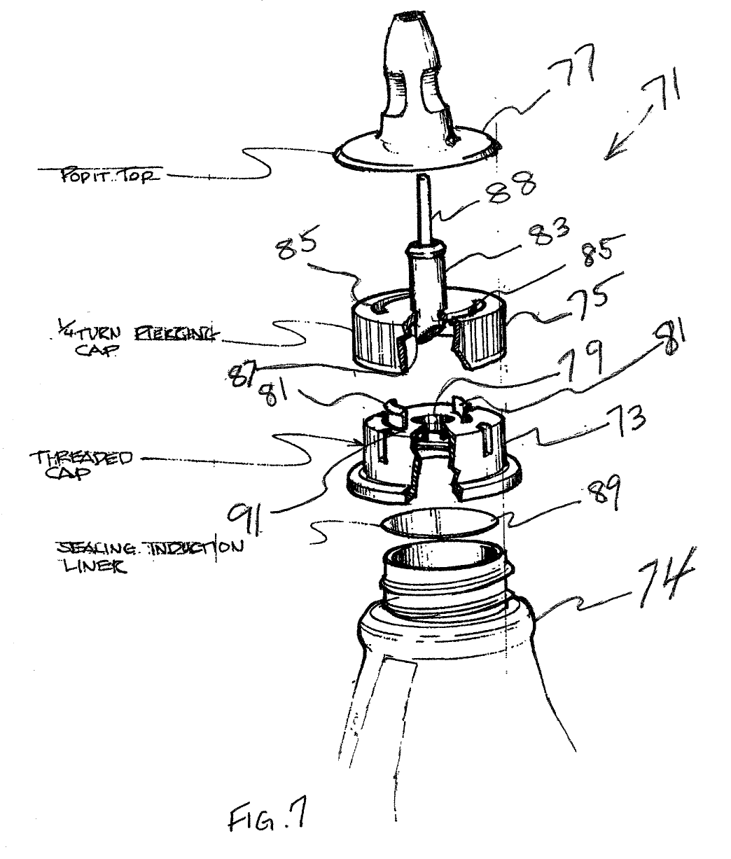

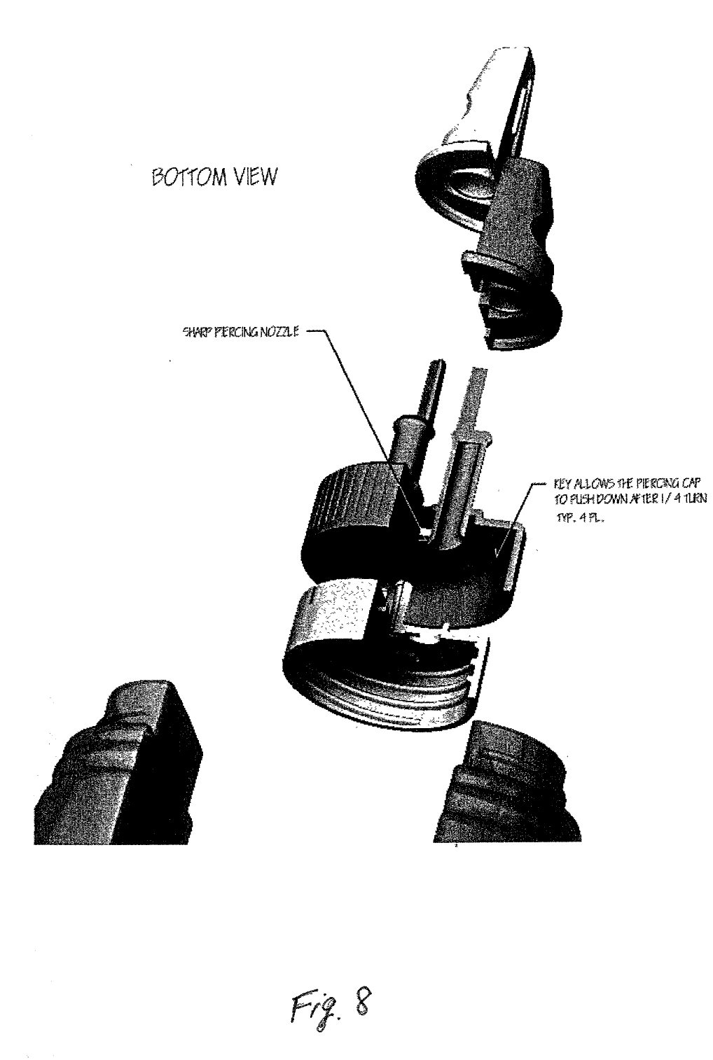

FIG. 4 provides a cross sectional view of five piece nozzle 26 along line I of FIG. 1. Retaining ring 33 is in the shipping position so that piercing ends 38A and 38B of conduits 36A and 36B are securely held above induction liner seal 27. However, as depicted in FIG. 5 when retaining ring 33 is removed nozzle 26 can be depressed forcing piercing tips 38A and 38B to cut through induction liner 27 to allow a flow able material in either chamber 23A or 23B to flow out through conduit 36A or 36B when the appropriate side of nozzle 26 is opened.

As depicted in FIG. 5 material contained in either chamber 23A or 23B can be removed from that chamber by putting the respective cap 41A or 341B in the open position. As depicted in FIG. 5, slide cap 41 B is in the open position and slide cap 41A is in the closed position. In the open position slide cap 41 B provides and open passage 51 through which material in chamber 23B can be caused to flow. Likewise when slide cap 41A is placed in the open position material in chamber 23A can be caused to flow through a like open passage. However, in the closed position as 41A is currently positioned the passage is closed off by abutment 53A. A similar abutment 53B is positioned on the other side but since slide cap 41B has been moved up the open position open passage 51 B has been created.

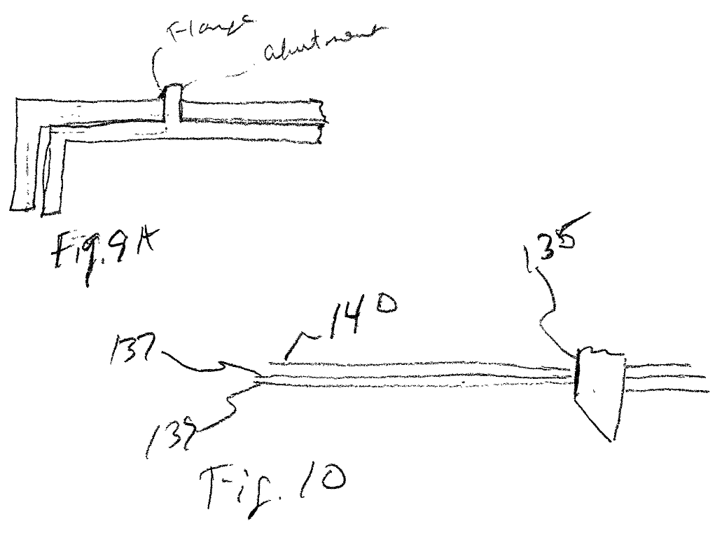

FIG. 7 is an exploded view of another version of the piercing cap or cover 71. The cover 71 has four parts. A base cap 73 which can be detachably connected to a container 74, a piercing cap portion 75 which, in the preferred embodiment snaps onto base cap portion 73 and a top portion that connects to the piercing cap portion. Base cap portion has a hole 79 in its center top and two spacing projections 81. Piercing cap portion 75 has a conduit 83 and spacer slots 85. Top cap portion 77 connects to the second end 88 of conduit 83. Seal or membrane 89 covers the mouth 90 of container 74.

When piecing cap portion 75 is connected to base cap portion 73 conduit 83 projects down through the opening 79 in base cap portion 73. When spacers 81 separate base cap portion 73 and piercing cap portion 75 the first end 87 of conduit 83 remains positioned above seal 89 out of contact with seat 89. When piercing cap portion 75 is rotated about base cap portion 73 and spacers 81 are lined up with spacer slots 85 piercing cap portion 75 can be pushed down to contact the first side 91 of base cap portion 73 and thereby cause first end 87 of piercing cap portion 75 to cut through seal or membrane 89. Top cap portion 77 is rotatably and slidably connected to the second end 88 of conduit 83. By rotating and sliding top cap portion 77 ingredients in container 74 can be forced from container 74 after seal 89 has been pierced by the first end of conduit 83.

FIGS. 8 and 9 show two different exploded view of another version of the piercing cap of the present invention. In this version the mechanism used to keep the cap portion separate from the piercing cap portion before use to prevent the piercing ends of the conduits from cutting the membrane are a key flange on the lower interior surface of the piercing cap portion and a key way or slot on the cap portion. When the key flange and the key way are not lined up with each other the key flange keeps the interior lower surface of the piercing cap separated from the top of the cap portion. This in turn keeps the lower cutting edges of the conduit out contact with the membrane and prevents them from cutting the membrane. When the piercing cap is rotated to position the flange key above the flange slot the piercing cap can be pushed down and the lower or first ends of the conduits will pierce the membrane. The caps also have an interlocking mechanism that causes will securely hold the piercing cap and cap portion together after the membrane is cut or pieced by the lower end of the conduits. This mechanism consists of a raised abutment or projection on the top of the cap portion that fits into a receiving slot on the piercing cap portion. Once joined a flange on the end of the abutment or projection causes the piercing cap and cap portion to interconnect as depicted in FIG. 9A. The cap portion in a preferred embodiment also has a center clip that fits into a receptacle in the piercing cap portion to hold it in position.

The membrane in the preferred embodiment is called an induction liner and when the piercing cap is forced down to cause the lower ends of the conduits 135 to pierce the membrane the conduits and membrane form a seal as depicted in FIG. 10. The seal is keep permanent by the interlocking mechanism described in the preceding paragraph. The liner in the preferred in embodiment is made up of three layers. It consists of a central foil layer 137 generally of aluminum or similar material. This gives it strength and structure. A layer of a plastic like material 139 is formed on the aluminum on the side of the membrane that faces the ingredients in the bottles when the membrane or induction layer is placed over the ends of the bottle to seal them. On the other side of the foil 137 a gel layer is formed such food grade silicon that facilitates the forming of the seal. In the version depicted the piercing end of the conduits are a slanted beveled pointed hollow tube end. However, other variations are possible such as a hollow cylindrical point with and opening to allow passage of ingredients from the bottles after the seal is made.

Use of food grade silicon or similar material allows the system to be used with human food products. As those skilled in the are will appreciate the system can also be used for delivery and use of hair shampoo and conditioner or a wide variety of other flowable materials. This can be dry flowable materials, such as salt and peper, as well as liquid. It can also be appreciated after a review of the above specification that the seal the system creates between the containers by the permanent connection of the piercing ends of the conduits and the induction liner prevents cross contamination of the product.

While the invention has been particularly shown and described with reference to a preferred embodiment thereof, it will be understood by those skilled in the art that various changes in form and detail may be made to it without departing from the spirit and scope of the invention.

We claim:

1. An ingredient delivery system comprising:
a) two symmetrical mirror image interlocking bottles with facing joinable surfaces with complementary raised and depressed areas on the joinable surface of each for positioning and joining the bottles together to form a single two-compartment container, and when joined together the open ends of the two mirror image bottles are adjacent to each other and are sealable with a piercable membrane;
b) a five piece-piercing cap attachable to the joined mirror image bottles comprising:
i) a threaded cap portion attachable by treads adjacent to the open ends of the mirror image bottles when they are joined to form the container;
ii) a piercing cap portion with two parallel conduits attachable to the threaded cap portion, each of the parallel conduits having a first end which projects down towards an open end of one of the bottles through openings in the threaded cap portion, the piercing cap also has one or more receptacles for receiving a retaining ring, which ring when inserted into the receptacles, positions the first end of each of the parallel conduits just above the piercalbe membrane covering the open ends of the joined mirror image bottles and upon removal of the retaining ring the piercing cap can be forced down to allow the piercing ends of each of the parallel conduits to cut through the membrane; and
iii) separate slidable closure caps on a second end of each parallel conduit, the slidable caps can be moved from a closed position to seal the respective chamber of the conduit to which it is or attached to an open position to allow ingredients to flow out of that chamber.

2. An ingredient delivery system comprising:
a) two interlocking bottles with facing joinable surfaces with a complementary interlocking mechanism on the joinable surface of each for positioning and joining the bottles together to form a single two-compartment container, and when joined together the open ends of the two mirror image bottles are adjacent to each other and are sealable with a piercable membrane;
b) a piece-piercing cap joinable to the mirror image bottles comprising:
i) a cap portion detachably connected to the adjacent open ends of the mirror image bottles when they are joined to form the container;
ii) a piercing cap portion with two parallel conduits, said piercing cap portion is detachably connected to the cap portion, each of the parallel conduits having a first end which projects down towards an open end of one of the bottles through openings in the cap portion, the piercing cap portion also has a positioning mechanism for positioning the first end of each of the parallel conduits just above a piercable membrane covering the open ends of the joined mirror image bottles and upon activation of the positioning mechanism the piercing cap portion can be forced down to allow the first end of each of the parallel conduits to cut through the membrane; and
iii) separate slidable closure caps on a second end of each parallel conduit, wherein the slidable caps can be moved from a closed position to seal the respective bottle the conduit projects towards to an open position to allow ingredients to flow out of that bottle.

3. The ingredient delivery system of claim 2 wherein the complementary interlocking mechanism is formed by complementary raised and depressed areas on the joinable surface of the bottles.

4. The ingredient delivery system of claim 2 wherein the complementary interlocking mechanism is formed by complementary shaped surfaces on the joinable surfaces of the bottles.

5. The ingredient delivery system of claim 2 wherein the cap portion is detachably connected to the adjacent open ends of the mirror image bottles by a thread on the cap portion that connects to a complementary threaded portion on the open end of the mirror image bottles.

6. The ingredient delivery system of claim 2 wherein the positioning mechanism is a retaining ring that inserts into the at least one receptacle on the piercing cap portion for receiving the retaining ring such that when the ring is inserted into the at least one receptacle the ring positions the first ends of each of the conduits just above the membrane such that when the ring is removed the piercing cap can then be forced down on to the membrane and allow the first end or each parallel conduit to cut through the membrane.

7. The ingredient delivery system of claim 2 wherein the positioning mechanism comprises at least on flange key that projects down from an inside bottom of the piercing cap portion and positions the first ends of each of the conduits from making contact with the membrane when the piercing cap is in a firs position with respect to the cap portion and when the piercing cap portion is rotated to a second position the at least one flange key fits into a key slot on the cap portion to allow the piercing cap portion to be moved down and thereby allow the first ends of each of the conduits to cut through the membrane.

8. The ingredient delivery system of claim 2 wherein the joinable bottles that form the container are symmetrical mirror image bottles.

9. The ingredient delivery system of claim 2 wherein the membrane is an induction liner comprising three layers a foil layer with a plastic layer on one side and a gel layer on the other side and wherein the membrane is attached to the bottles to form the seal with the plastic layer facing into the bottles.

10. The ingredient delivery system of claim 9 wherein when the first ends of the conduits of the piercing cap cut through the membrane the conduits form a seal with the membrane to provide a sealed passage for ingredients in the bottle up through the conduit which projects down towards the bottle through the membrane.

11. The ingredient delivery system of claim 2 wherein when the first ends of the conduits of the piercing cap cut through the membrane the conduits form a seal with the membrane to provide a sealed passage for ingredients in the bottle up through the conduit which projects down towards the bottle through the membrane.

12. The ingredient delivery system of claim 2 wherein the two interlocking bottles once joined at their joinable surfaces are held together by a joining mechanism.

13. The ingredient delivery system of claim 2 wherein joining mechanism holding the bottles together is and adhesive between the joinable surfaces.

14. The ingredient delivery system of claim 2 wherein then joining mechanism holding the two interlocking bottles together is a shrink-wrap covering.

15. The ingredient delivery system of claim 2 wherein the cap portion and the piercing cap portion are held in a position where the first ends of the conduits can not cut the membrane by a restraining mechanism.

16. The ingredient delivery system of claim 15 wherein the restraining mechanism is a shrink-wrap covering around the cap portion and the piercing cap portion.

17. The ingredient delivery system of claim 2 wherein the two interlocking bottles and are held together by a shrink-wrap covering which also covers the piercing cap portion to hold the cap portion and piercing cap portion in position to prevent cutting of the membrane by the first ends of the conduits prior to use, with a perforation around the shrink-wrap covering at a position where the cap joins the container so that the shrink-wrap covering the cap can be removed to thereby allow the piercing cap to be positioned to cut the membrane but leave the shrink-wrap on the bottles to continue to hold them together.

18. The ingredient delivery system of claim 2 further comprising an interlocking mechanism to hold the piercing cap portion in a fixed position with respect to the cap portion once the positioning mechanism has been activated and the first ends of each of the conduits have cut the membrane to thereby hold the conduits in position with the membrane so that a seal formed between the first ends of the conduits and the membrane is maintained.

19. The ingredient delivery system of claim 18 wherein the interlocking mechanism is formed by at least one raised structure on a surface of the cap portion that faces the piercing cap portion, which raised structure projects up towards the piercing cap and wherein when the piercing cap portion is activated to cause the first ends of the conduits to cut the membrane by forcing the piercing cap portion towards the cap portion the raised structure projects into an opening on the piercing cap portion and a flange on the end of the raised structure causes the cap portion and piercing cap portion to be interlocked together.

20. The ingredient delivery system of claim 19 wherein the piercing cap is activated by twisting the piercing cap portion to a predefined position and then pushing the piercing cap portion down towards the cap portion.

21. A dual chamber ingredient container comprising: two symmetrical mirror image interlocking bottles with facing joinable surfaces with a complementary interlocking mechanism on the joinable surface of each for positioning and joining the bottles together to form a single two-compartment container, and when joined together the open ends of the two mirror image bottles are adjacent to each other and are sealable with a piercable membrane.

22. The dual chamber ingredient system of claim 21 wherein the complementary interlocking mechanism is formed by complementary raised and depressed areas on the joinable surface of the symmetrical mirror image interlocking bottles.

23. A piercing cap for a dual compartment container comprising:
a) a cap portion detachably connected to the adjacent open ends of a two compartment container;
b) a piercing cap portion with two parallel conduits, said piercing cap portion is detachably connected to the cap portion, each of the parallel conduits having a first end which projects down towards an open end of one of the compartments of the container through openings in the cap portion, the piercing cap also has a removable positioning device for positioning the first end of each of the parallel conduits just above the piercable membrane covering the open ends of the two compartment container and upon removal of the removable positioning device the piercing cap can be forced down to allow the piercing ends of each of the parallel conduits to cut through the membrane; and
c) separate slidable closure caps on a second end of each parallel conduit, the slidable caps can be moved from a closed position to seal the respective compartment the conduit is positioned above to an open position to allow ingredients to flow out of that compartment.

24. The piecing cap of claim 23 wherein the cap portion is detachably connected to the adjacent open ends of the mirror image bottles by a thread on the cap portion that connects to a complementary threaded portion on the open end of the mirror image bottles.

25. The piecing cap of claim 23 wherein the removable positioning device is a retaining ring that inserts into the at least one receptacle on the piercing cap portion for receiving the retaining ring such that when the ring is inserted into the at least one receptacle the ring positions the first ends of each of the conduits just above the membrane such that when the ring is removed the piercing cap can then be forced down on to the membrane and allow the first end or each parallel conduit to cut through the membrane.

26. A method for fabricating a dual compartment container comprising:
making mirror image containers with complementary joinable surfaces;
providing on the complementary joinable surfaces a complementary interlocking device; and
joining the mirror image containers to form the dual compartment container.

27. A container cover comprising:
a) a base cap portion detachably connectable to the mouth of a container, said base cap portion having a spacing device on a first surface that faces away from the mouth of the container when said base cap portion is connected to the container and a second side facing into the container;
b) a piercing cap portion detachably connectable to the first side of said base cap portion, said piercing cap portion having at least one conduit with a first end of said conduit projecting down through an opening of said base cap portion when said base cap portion and piercing cap portion are connected together;
c) a top cap portion that rotatably and slidably connects to a second end of the at least one conduit of said piercing cap portion; and
d) wherein said piercing cap portion when rotated about said base cap portion with said spacing device separating said piercing cap portion and said base cap portion, said spacing device being positionable below an opening in said piercing cap portion to allow said piercing cap portion to be moved down and contact the first side of said base cap portion and wherein when said spacing device separates said base cap portion and said piercing cap portion the first end of said conduit is positioned above and out of contact with a seal over the container the cover is attached to, so that when said piercing cap portion is rotated to allow the spacing device to be positioned below said opening in said piercing cap portion and said piercing cap portion is moved down to contact said first side of said base cap portion the first end of said conduit comes in contact with said seal on the mouth of the bottle and cuts an opening in the seal to allow ingredients to flow out of the container.
